(19) United States
(12) Patent Application Publication
(10) Pub. No.: US 2010/0180132 A1
(43) Pub. Date: Jul. 15, 2010

(54) Power Management Device for a Computer System and Related Power Management Method and Computer System

(76) Inventors: Te-Lung Wu, Taipei Hsien (TW); Ho-Nien Yu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/626,954

(22) Filed: Nov. 30, 2009

(30) Foreign Application Priority Data
Jan. 15, 2009 (TW) 098101366

(51) Int. Cl. G06F 1/26

(52) U.S. Cl. 713/300

(57) ABSTRACT

A power management device for a computer system includes a detection unit coupled to a peripheral interface of the computer system for detecting whether a portable electronic device is coupled to the peripheral interface when the computer system is shut down, to generate a detection result, and a control unit coupled to the detection unit and a power supply device of the computer system for controlling the power supply device to output a charge current to the portable electronic device via the peripheral interface when the detection result indicates that the portable electronic device is coupled to the peripheral interface.

### BACKGROUND OF THE INVENTION

1. Field of the Invention

The present invention is related to a power management device for a computer system and related power management method and computer system, and more particularly, to a power management device and related power management method and computer system capable of enhancing utilization convenience and effectively reducing power dissipation.

2. Description of the Prior Art

USB (Universal Serial Bus), a convenient and low-cost connecting solution, supports “hot attach and detach” and “plug and play”, and has advantages of excellent extensibility, simple installation, high transmission rate, etc. Therefore, USB is widely applied in computer systems. In addition, since USB can simultaneously exchange data and provide power, portable electronic devices, such as mobile phones, personal digital assistants (PDAs), etc., have adopted USB.

In general, a portable electronic device comprises a rechargeable battery, for providing electric power required. When power is insufficient, a user can replace the battery or use a charger to charge the battery. A typical portable electronic device is usually equipped with an individual battery charger, to meet a required charging voltage, e.g. 3.6V, 5V, or 12V. However, with the popularity of USB, most portable electronic devices are equipped with a USB port, such as a mini USB port, to provide functions of data exchange and battery charging. In such a situation, when charging the portable electronic device, the user can link the portable electronic device and the computer system, to charge the portable electronic device via USB interface. However, such operation can work only when the computer system is powered on, causing utilization inconvenience, especially for a notebook computer. That is, the user has to turn on the notebook computer first, and charges the portable electronic device via USB, which leads to utilization inconvenience, accelerates power dissipation of the notebook computer, and therefore, shortens utilization time of the notebook computer.

### SUMMARY OF THE INVENTION

It is therefore a primary objective of the claimed invention to provide a power management device for a computer system and related power management method and computer system.

The present invention discloses a power management device for a computer system, which comprises a detection unit, coupled to a peripheral interface of the computer system, for detecting whether a portable electronic device is coupled to the peripheral interface of the computer system when the computer system is shut down, to generate a detection result, and a control unit, coupled to the detection unit and a power supply device of the computer system, for controlling the power supply device to output a charge current to the portable electronic device via the peripheral interface when the detection result indicates that the portable electronic device is coupled to the peripheral interface.

The present invention further discloses a power management method for a computer system, which comprises detecting whether a portable electronic device is coupled to a peripheral interface of the computer system when the computer system is shut down, and outputting a charge current to the portable electronic device via the peripheral interface when the portable electronic device is coupled to the peripheral interface.

The present invention further discloses a computer system capable of saving power, which comprises a system circuit, for performing functions of the computer system. The system circuit comprises a peripheral interface, a power supply device, coupled to the system circuit, for providing power to the system circuit, and a power management device. The power management device comprises a detection unit, coupled to the peripheral interface, for detecting whether a portable electronic device is coupled to the peripheral interface when the computer system is shut down, to generate a detection result, and a control unit, coupled to the detection unit and the power supply device, for controlling the power supply device to output a charge current to the portable electronic device via the peripheral interface when the detection result indicates that the portable electronic device is coupled to the peripheral interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer system according to an embodiment of the present invention.

FIG. 2 is a schematic diagram of a power management process according to an embodiment of the present invention.

### DETAILED DESCRIPTION

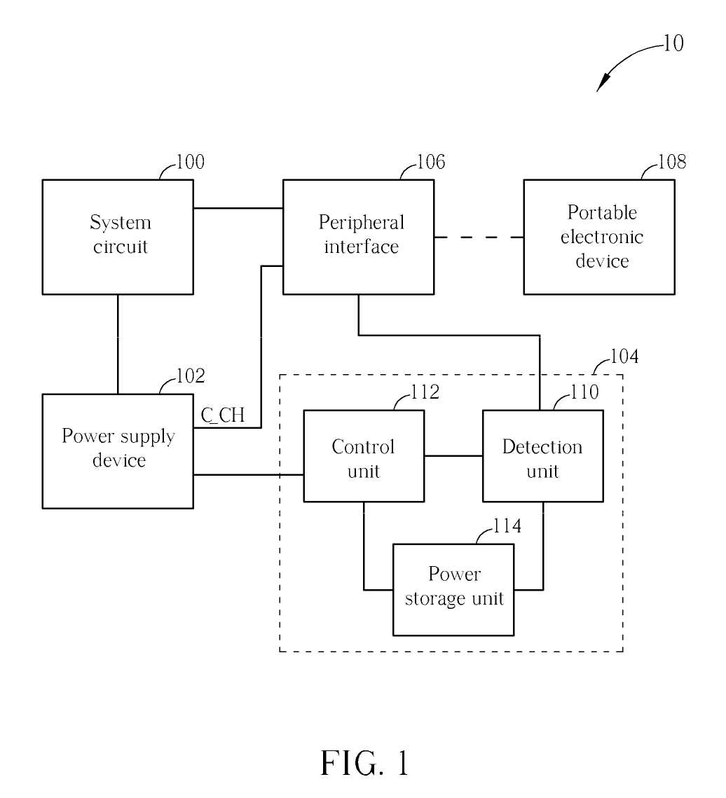

Please refer to FIG. 1, which is a schematic diagram of a computer system 10 according to an embodiment of the present invention. Preferably, the computer system 10 is a notebook computer, and can save power. The computer system 10 comprises a system circuit 100, a power supply device 102 and a power management device 104. The system circuit 100 is utilized for implementing functions of the computer system 10, and is coupled to a portable electronic device 108 via a peripheral interface 106. The peripheral interface 106 can be a universal serial bus (USB) interface, an IEEE 1394 interface or other common interfaces of computer systems. The electronic device 108 can be a mobile phone, a smart phone, a personal digital assistant (PDA), etc. The power supply device 102 is utilized for providing electric power to the system circuit 100 and the peripheral interface 106, and can include a rechargeable battery, an AC-DC converter, etc. The architecture of the power supply device 102 is well-known to those skilled in the art, and no more description thereof is given for the sake of brevity. In addition, the power management device 104 can control the power supply device 102 whether to provide power to the peripheral interface 106. The power management device 104 comprises a detection unit 110, a control unit 112 and a power storage unit 114. The power storage unit 114 is utilized for providing electric power to the detection unit 110 and the control unit 112 when the computer system 10 is shut down, so that the detection unit 110 and the control unit 112 can operate when the computer system 10 is shut down. The detection unit 110 is utilized for detecting whether the portable electronic device 108 is coupled to the peripheral interface 106 when the computer system 10 is shut down. The control unit 112 is utilized for controlling the power supply device 102 to output a charge current C_CH to the portable electronic device 108 via the peripheral interface 106 when a detection result of the detection unit 110 indicates that the portable electronic device 108 is coupled to the peripheral interface 106.

In short, when the computer system 10 is shut down, the detection unit 110 detects whether the portable electronic device 108 is coupled to the peripheral interface 106. If true, the control unit 112 controls the power supply device 102 to output the charge current C_CH to the portable electronic device 108 via the peripheral interface 106, to charge the portable electronic device 108. That is, when the computer system 10 is shut down, the present invention can control the power supply device 102 to charge the external portable electronic device 108. Since there is no need to boot the computer system 10 to charge the portable electronic device 108, the present invention can greatly enhance utilization convenience, and more importantly, can reduce power dissipation of the computer system 10.

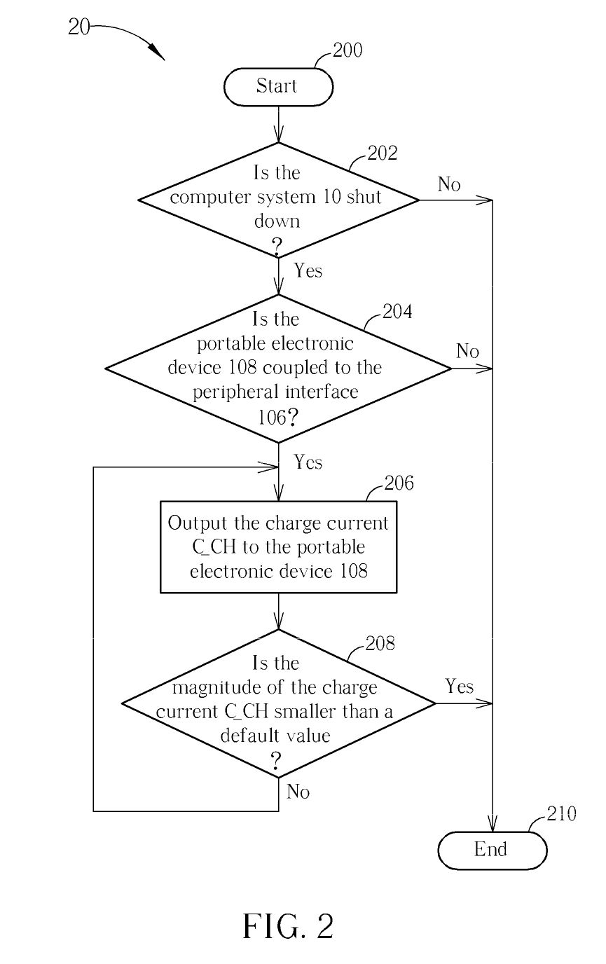

Note that, the computer system 10 illustrated in FIG. 2 is an embodiment of the present invention, and certainly, those skilled in the art can make modifications or variations accordingly. For example, the power storage unit 114, utilized for providing electric power to the detection unit 110 and the control unit 112 when the computer system 10 is shut down, can be embedded in the power supply device 102. Moreover, when the computer system 10 is shut down and the power supply device 102 is charging the portable electronic device 108, the present invention can further use the detection unit 110 to detect variation of the charge current C_CH outputted by the portable electronic device 108 via the peripheral interface 106, and use the control unit 112 to control the power supply device 102 to stop outputting the charge current C_CH to the portable electronic device 108 when a magnitude of the charge current C_CH is smaller than a default value. In such a situation, if the portable electronic device 108 is fully charged, or a device coupled to the peripheral interface 106 is not a chargeable device, such as a mouse, the present invention can prevent the power supply device 102 from providing power, to further reduce power dissipation.

In the prior art, when the computer system is shut down, the peripheral interface cannot provide power; therefore, the computer system must be booted, to charge the external portable electronic device, causing utilization inconvenience and increasing power dissipation. In comparison, in the present invention, when the computer system 10 is shut down and the portable electronic device 108 is coupled to the peripheral interface 106, the power management device 104 can control the power supply device 102 to provide electric power to the portable electronic device 108, and can stop charging when the portable electronic device 108 is fully-charged. As a result, the present invention can enhance utilization convenience and effectively reduce power dissipation.

Operations of the power management device 104 can be further summarized to a power management process 20 as shown in FIG. 2. The power management process 20 comprises the following steps:

Step 200: Start.

Step 202: Determine whether the computer system 10 is shut down. If yes, proceed to Step 204; else, proceed to Step 210.

Step 204: The detection unit 110 detects whether the portable electronic device 108 is coupled to the peripheral interface 106. If yes, proceed to Step 206; else, proceed to Step 210.

Step 206: The control unit 112 controls the power supply device 102 to output the charge current C_CH to the portable electronic device 108 via the peripheral interface 106.

Step 208: The detection unit 110 detects whether the magnitude of the charge current C_CH is smaller than a default value. If yes, proceed to Step 210; else, return to Step 206.

Step 210: End.

The power management process 20 is related to the operations of the power management device 104, and description thereof can be referred in the above and not given herein for the sake of brevity.

To sum up, when the computer system is shut down, and the portable electronic device is coupled to the peripheral interface, the present invention can control the power supply device to output the charge current to the portable electronic device via the peripheral interface, to charge the portable electronic device, and can stop charging when there is no need to charge the portable electronic device. Therefore, the present invention can enhance utilization convenience and effectively reduce power dissipation.

Those skilled in the art will readily observe that numerous modifications and alterations of the device and method may be made while retaining the teachings of the invention.

What is claimed is:

1. A power management device for a computer system comprising:
a detection unit, coupled to a peripheral interface of the computer system, for detecting whether a portable electronic device is coupled to the peripheral interface of the computer system when the computer system is shut down, to generate a detection result; and
a control unit, coupled to the detection unit and a power supply device of the computer system, for controlling the power supply device to output a charge current to the portable electronic device via the peripheral interface when the detection result indicates that the portable electronic device is coupled to the peripheral interface.

2. The power management device of claim 1, wherein the detection unit is further utilized for detecting a magnitude of the charge current.

3. The power management device of claim 2, wherein the control unit is further utilized for controlling the power supply device to stop outputting the charge current to the portable electronic device via the peripheral interface when the magnitude of the charge current is smaller than a default value.

4. The power management device of claim 1 further comprising a power storage unit, for providing power to the detection unit and the control unit when the computer system is shut down.

5. The power management device of claim 1, wherein the computer system is a notebook computer.

6. The power management device of claim 1, wherein the peripheral interface is a universal serial bus interface.

7. The power management device of claim 1, wherein the peripheral interface is an IEEE 1394 interface.

8. A power management method for a computer system comprising:
detecting whether a portable electronic device is coupled to a peripheral interface of the computer system when the computer system is shut down; and
outputting a charge current to the portable electronic device via the peripheral interface when the portable electronic device is coupled to the peripheral interface.

9. The power management method of claim 8 further comprising detecting a magnitude of the charge current.

10. The power management method of claim 9 further comprising stopping outputting the charge current to the portable electronic device via the peripheral interface when the magnitude of the charge current is smaller than a default value.

11. The power management method of claim 8, wherein the computer system is a notebook computer.

12. The power management method of claim 8, wherein the peripheral interface is a universal serial bus interface.

13. A computer system capable of saving power comprising:
a system circuit, for performing functions of the computer system, comprising a peripheral interface;
a power supply device, coupled to the system circuit, for providing power to the system circuit; and
a power management device comprising:
a detection unit, coupled to the peripheral interface, for detecting whether a portable electronic device is coupled to the peripheral interface when the computer system is shut down, to generate a detection result; and
a control unit, coupled to the detection unit and the power supply device, for controlling the power supply device to output a charge current to the portable electronic device via the peripheral interface when the detection result indicates that the portable electronic device is coupled to the peripheral interface.

14. The computer system of claim 13, wherein the detection unit is further utilized for detecting a magnitude of the charge current.

15. The computer system of claim 14, wherein the control unit is further utilized for controlling the power supply device to stop outputting the charge current to the portable electronic device via the peripheral interface when the magnitude of the charge current is smaller than a default value.

16. The computer system of claim 13 further comprising a power storage unit, for providing power to the detection unit and the control unit when the computer system is shut down.

17. The computer system of claim 16, wherein the power storage unit is embedded in the power supply device.

18. The computer system of claim 13, wherein the computer system is a notebook computer.

19. The computer system of claim 13, wherein the peripheral interface is a universal serial bus interface.

20. The computer system of claim 13, wherein the peripheral interface is an IEEE 1394 interface.
